(19) United States
(12) Patent Application Publication
(10) Pub. No.: US 2025/0187212 A1
(43) Pub. Date: Jun. 12, 2025

(54) EXPLOSION PROOF LEGGED ROBOT

(71) Applicants: ANYBOTICS AG, Zürich (CH); PETROLIAM NASIONAL BERHAD (PETRONAS), Kuala Lumpur (MY)

(72) Inventors: Tobias Wiesand, Zurich (CH); Taihei Ueno, Zürich (CH); Simon Mark Holt, Emenswil (CH); Alessandro Schiavone Scafato, Schwerzenbach (CH); Mehmet Mutlu, Dietlikon (CH); Asmadi Mansor, Kajang (MY); Iskandar Al-Thani Mahmood, Kajang (MY)

(21) Appl. No.: 18/844,430

(22) PCT Filed: Mar. 9, 2022
(86) PCT No.: PCT/EP2022/056084

§ 371 Date: Sep. 6, 2024

(51) Int. Cl. B25J 19/00; B25J 13/08; B25J 19/06; B62D 57/032

(52) U.S. Cl. CPC B25J 19/0079; B25J 13/087; B25J 19/005; B25J 19/06; B62D 57/032

(57) ABSTRACT

The invention refers to a legged robot (1000) comprising a torso (1) with a cavity (10) enclosing at least one robot component (11) and at least one leg with at least one actuator (100) that comprises an explosion proof housing. An absolute pressure (P_{c}) within the cavity (10) is higher than an ambient pressure (Pₐ), and wherein the explosion proof housing of the actuator (100) comprises at least one flame proof gap (105).

### TECHNICAL FIELD

The present invention refers to a legged robot, a cable gland for the legged robot, an actuator for the legged robot, a method to provide an explosion proof robot and a use of the legged robot.

### BACKGROUND ART

Legged robots are used for various tasks, in particular for supporting human work in hazardous environments. Usually, a legged robot comprises one or more legs.

To use a legged robot in an explosive environment, in particular explosive gas or dust, it is advantageous if the robot is constructed to fulfil some precaution measures. For example, the robot should be constructed in a way that it does not ignite explosions in such an environment.

One challenge in this regard is to construct the robot in such a way that it does not explode if e.g. explosive gas enters the robot torso or an actuator of the robot.

Prior art robots might fulfil these requirements by comprising a full body shell that encloses all robot parts hermetically sealed against the ambient environment. Anyway, such a robot construction might be very heavy and therefore expensive.

### DISCLOSURE OF THE INVENTION

The problem to be solved by the present invention is therefore to provide a legged robot that overcomes the disadvantages of the prior art.

This problem is solved by a first aspect of the invention referring to a legged robot, a second aspect of the invention referring to a cable gland for the legged robot, a third aspect of the invention referring to an explosion proof actuator, a fourth aspect of the invention referring to a method to provide an explosion proof legged robot and a fifth aspect refers to a use of the legged robot.

Unless otherwise stated, the following definitions shall apply in this specification:

The terms “a”, “an”, “the” and similar terms used in the context of the present invention are to be construed to cover both the singular and plural unless otherwise indicated herein or clearly contradicted by the context. Further, the terms “including”, “containing” and “comprising” are used herein in their open, non-limiting sense. The “containing” term shall include both, “comprising” and “consisting of”.

Advantageously, the term “ambient” refers to a condition of the environment around the robot. In particular, “ambient pressure” refers to the pressure of the surrounding environment of the robot.

Advantageously, the term “in fluid connection” refers to spaces or cavities that are connected to each other such that a fluid, e.g. a gas or air or a liquid, can flow from one space or cavity to the other. Therefore, if spaces or cavities are in fluid connection, they might be surrounded by the same gas or same air or same liquid.

Advantageously, the term “explosion proof housing” refers to a housing that can withstand and contain the explosion inside the housing to prevent from propagating the explosion to the outside of the housing.

Advantageously, such explosion proof characteristic of the housing is achieved by means of the following features, individually or in combination:
Flame proof gaps: flame proof gaps are gaps that are big enough that air or gas can circulate from the environment into the housing, but are small enough to prohibit that potential fires that are released by an explosion within the housing can get to the outside of the housing and ignite the environment.
In an advantageous embodiment, the flame gaps of the housing of the dynamic joint have a minimum of 6 mm in length and less than 0.2 mm in width.
Flame proof material: The housing is built of a flame proof material, for example aluminum or steel or PEEK (Polyether ether ketone).
Wall thickness of the housing: The wall thickness is constructed such that it can withstand explosions.

The first aspect of the invention refers to a legged robot, in particular a quadruped robot comprising a torso with a cavity, wherein the cavity encloses at least one robot component. Furthermore, the robot comprises at least one leg with at least one actuator, wherein the actuator comprises an explosion proof housing. The leg might further advantageously also comprise a second or a further actuator with a respective explosion proof housing each.

The explosion proof housing might comprises multiple housings or sections that are still defined as being part of the explosion proof housing of the actuator.

Advantageously, the torso is the main body of the robot, where most of the computing power and electronic components are located.

In particular, the cavity is the inner space within a robot torso, wherein different components of the robot are located. In particular, the cavity is the room within the robot torso that is sealed towards the environment and has the same absolute pressure p_{c} all over the cavity. That means, all the space within the robot that is in fluid connection is part of the cavity.

An absolute pressure p_{c} within the cavity is higher than an ambient pressure pₐ. To achieve this overpressure, the cavity is advantageously filled with nitrogen gas. The technical effect of the overpressure is to avoid any penetration of environmental gas or dust into the cavity and therefore to prevent an explosion within the cavity.

Advantageously, the actuator is a part of a leg of the robot that comprises one or more actuators, in particular two or three actuators, for moving the leg.

In a further advantageous embodiment of the invention, the actuator is directly adjacent to the torso.

In a further advantageous embodiment, the actuator is a hip abduction/adduction (HAA) actuator.

In addition, the housing of the actuator is adapted to be flame proof. In particular, a flame proof housing refers to a housing that can withstand and contain an explosion inside the housing, to prevent from propagating the explosion to outside of the housing.

The explosion proof housing of the actuator comprises at least one flame proof gap.

In particular, the flame proof gaps do not prevent the ignition inside the housing. They only make sure that the flames cannot exit and ignite the gas outside.

Advantageously, the at least one flame proof gap of the housing of the actuator has a minimum of 6 mm in length and less than 0.2 mm in width.

Only the combination of the torso with the overpressure and the actuator with the explosion proof housing, provides the legged robot that is explosion proof towards the environment, meaning that it prevents ignition of the environment.

Advantageously, the housing of the actuator is gas tight. In the housing, there might be environment gas or might be nitrogen. Advantageously, the actuator is assembled under environmental conditions and therefore there might be environmental conditions within the housing. Different sections of housings might be assembled together to form the explosion proof housing for the actuator. O-rings might be used between the individual sections of the housing to seal the housing. Anyway, the O-rings might fail to seal the interfaces between the sections of the explosion proof house and therefore environmental gas might enter the explosion proof housing of the actuator.

Therefore, the housing geometry, casing interfaces or flanges are adapted to be flame proof. In contrast, the cavity of the robot torso is not in fluid connection with the environment (and therefore no environmental gas or dust is entering the cavity), to prevent ignition of the robot torso.

In a further advantageous embodiment of the invention, the actuator comprises a dynamic joint with a moving section and a static section with the at least one flame proof gap arranged at the interface of the moving section and the static section.

Advantageously, a dynamic joint is dynamically connecting two bodies, wherein the dynamic joint comprises one moving or rotating part, such as a rotating shaft or piston, and one static part, for example: an output flange, or a stator of an electric motor or cylinder for a moving piston of a hydraulic or pneumatic actuator, to establish the connection.

In a further advantageous embodiment of the invention, the actuator comprises within the explosion proof housing the following sections arranged along a longitudinal axis:
a dynamic joint with a moving shaft as the moving section and a output flange as the static section, wherein the moving shaft is in particular adapted to connect the actuator to a shank of the robot leg,
a gear housing, in particular comprising a torque measurement system,
a stator housing, and
a back cap,
wherein between each section, a flame proof gap is arranged.

In an advantageous embodiment of the invention, the flame proof gaps are arranged everywhere between the individual sections, where O-rings should seal the interfaces. If an O-ring is not absolutely tight sealing the interface between two sections, gas or dust from the environment might enter the housing of the respective section that is part of the housing of the actuator. This might lead to explosions within the respective section or within multiple sections. The flame gaps prevent that an overpressure builds within the respective section like a pressure vent, but are small enough that flames that might build within the sections cannot exit the respective section of the housing.

Advantageously, one or more flame gaps are arranged between the interface of the moving section and the static section of a dynamic joint, and/or between the interface of the static section of the dynamic joint and the gear housing, and/or between the interface of the gear housing and the stator housing, and/or between the interface of the stator housing and the back cap.

Advantageously, a differential pressure p_{d}, is the difference between the absolute pressure p_{c} within the cavity and the ambient pressure pₐ outside the robot torso, such that p_{f}=p_{c}−pₐ. In an advantageous embodiment of the invention, the differential pressure p_{d} is p_{d}≥500 Pa. The overpressure in the torso has the technical effect that the torso might not ignite in an explosive environment. In particular, the torso is hermetically sealed. If anyway any of the hermetic sealing is broken, gas and dust might not enter the torso due to the overpressure in the torso.

In a further advantageous embodiment, the legged robot further comprises a DC fan to cool down some cooling ribs at the outside of the robot torso, for cooling down the inner parts of the torso. In particular, the DC fan is also adapted to be explosion proof. Advantageously, also the housing of the DC fan comprises flame proof gaps to prevent ignition of an explosion outside of the robot.

In a further advantageous embodiment of the invention, at least one robot component is a LiDAR, a sensor element, an electronic component, a battery and/or a camera. One or more of these components are in fluid connection with the cavity. Therefore, the one or more components are in particular in an environment with an absolute pressure p_{c} and in fluid connection with each other (if there are more than one components).

Advantageously, the robot component is pressure sensor unit for measuring the absolute pressure p_{c} within the cavity.

In a further advantageous embodiment, the robot comprises a differential pressure sensor unit for measuring the differential pressure p_{d}. In particular, such a differential pressure sensor unit would comprise two subcomponents, an absolute pressure sensor to measure the absolute pressure p_{c} within the cavity and an ambient pressure sensor to measure the ambient pressure pₐ outside of the robot. The ambient pressure sensor might be arranged at an outside of the robot torso and therefore at an outside of the cavity. The absolute pressure sensor is arranged as a robot component within the cavity.

Alternatively, the pressure sensor unit might comprise only one sensor element that is adapted to measure both, the absolute pressure p_{c} inside the cavity and the ambient pressure pₐ outside the cavity respectively outside the torso. Such a sensor element might comprise a membrane that is arranged between the cavity and the environment.

In a further advantageous embodiment of the invention, the legged robot comprises a gas tight cable gland to electrically connect a wire from the actuator to one or more of the robot components in the cavity without flooding the cavity with environmental gas or dust. As mentioned above, within the explosion proof housing of the actuator, there might be environmental conditions, but the cavity is hermetically sealed against the environment. Therefore, a particular cable gland is needed to connect electronic wires from the actuator to the components within the cavity, without risking to bring gas or dust from the environment or the actuator into the torso, respectively into the cavity.

Advantageously, the cable gland comprises a separator with at least one cable inlet and at least one cable outlet. At least one cable connection is adapted to connect an electrical component of the actuator or the dynamic joint or any other section of the actuator to one or more electrical components and/or a battery within the cavity of the robot torso.

The cable connection enters the cable gland through the cable inlet and exits the cable gland through the cable outlet. A bare section of the cable connection is arranged within the separator, wherein the cable jacket is removed from that bare section.

The bare section has the technical effect that all the gas that might be within the individual wires of the cable (within the cable jacket) goes out of the wire and ends up in the separator. Therefore, gas that might have travelled from the actuator through the cable until the cable gland or might enter the cable inlet from the environment, escapes out of the cable in the separator. To prevent that the cable that exits the separator has gas between the individual cable wires, the bare section is soldered up with a solder paste. In addition, the separator is filled with an insulating material, for example glue. By filling up the bare section of the cable with the solder paste and the enclosing separator with an insulating material, no gas from the outside can exit the cable gland on the exit side of the cable, e.g. towards the cavity.

In a further advantageous embodiment of the invention, at least one electrical component of the at least one actuator is electrically connected to one or more electrical components and/or a battery is arranged within the cavity, in particular by means of a wire that passes the cable gland.

In a further advantageous embodiment of the invention, the legged robot comprises a safety unit to recognize the differential pressure p_{f}. In an intended use of the legged robot, the safety unit is adapted to monitor the differential pressure p_{f} and to run a safety measure if the differential pressure p_{f} is below a predefined pressure value, in particular if p_{f}≤500 Pa, very particular if p_{d}≤50 Pa.

Advantageously, the safety measure is
a shutdown of the robot, in particular if p_{d}≤50 Pa,
a return of the robot to the safety zone, in particular if p_{d}≤500 Pa, or
a return of the robot to the docking station.

In a further advantageous embodiment of the legged robot, the legged robot comprises a gas cartridge, in particular a nitrogen cartridge, adapted to control the cavity pressure p_{c} . . . Therefore, the absolute pressure p_{c} in the cavity can be controlled. If the pressure p_{c} drops, it can be restored by adapting it with the cartridge.

Advantageously, the cartridge is adapted to fill the cavity with gas from the cartridge if the differential pressure is p_{d}≤500 Pa.

Advantageously, the refilling of the gas from the cartridge is an automatic process, but it can also be controlled by means of a remote controller or manually.

A second aspect of the invention refers a cable gland for a robot. The cable gland comprises a separator with at least one cable inlet and at least one cable outlet,
wherein the cable inlet is adapted to receive at least one cable connection adapted to connect an electrical component of the actuator of the leg of the robot,
wherein the cable outlet is adapted to exit the cable connection adapted to connect to one or more electrical components and/or a battery within the cavity of the torso, and,
wherein the separator is adapted to receive a bare section of the cable connection. The bare section in particular refers to a section of the cable connection along which the cable connection that has no cable jacket.

In a further advantageous embodiment of the cable gland, the cable gland comprises a separator with at least one cable outlet. In addition, the cable gland comprises at least one cable connection adapted to connect an electrical component of the actuator of the robot to one or more electrical components and/or a battery within the cavity. The cable connection enters the cable gland through the cable inlet and exits the cable gland through the cable outlet, and

wherein a bare section of the cable connection is arranged within the separator and has no cable jacket.

In a further advantageous embodiment of the cable gland, the bare section is soldered up with a solder paste, e.g. a conductive material, in particular a metal, to prevent gas accumulation between the individual wires of the bare section. In addition, the separator is filled respectively potted with an insulating material, advantageously, an insulating glue.

In particular, by means of the cable gland it is possible to build a legged robot that has outer parts, like legs that are connected by the dynamic joint to the torso, which outer parts are not under overpressure conditions. The cable gland according to the invention prevents that gas or dust from the ambient environment can enter the torso, since all the gas that might be in the cable or in the explosion proof housing of the actuator or in the environment is prevented to leave the cable gland through the cable outlet because the bare section is filled with solder paste and the environment in the separator is filled with glue. Therefore, there is no space for a gas to travel through the separator and therefore through the cable gland.

By means of this construction, outer components of the robot, like the legs, can be built in a lightweight construction, since they are not in fluid connection with the cavity. Therefore, the combination of the actuator, the cable gland and the over pressured torso result in a legged robot that does not ignite in an explosive environment but is still lightweight.

Therefore, the combination of the overpressure cavity in the torso, the dynamic joint with the housing that is at ambient conditions and the cable gland is advantageous over prior art.

A third aspect of the invention refers to a actuator enclosed by an explosion proof housing, wherein the housing comprises at least one flame proof gap, adapted to be comprised in a leg for a robot according to the first aspect.

A fourth aspect of the invention refers to a method to provide an explosion proof legged robot. The legged robot comprises a torso with a cavity that enclosed at least one robot component. In addition, the robot comprises at least one leg with at least one actuator, wherein the actuator is enclosed by an explosion proof housing. The explosion proof housing comprises at least one flame proof gap.

In addition, the legged robot comprises a pressure sensor unit adapted to measure a differential pressure p_{d} between a cavity pressure p_{c} and an ambient pressure pₐ, wherein p_{c}>pₐ.

A safety unit is further integrated into the robot, which safety unit is adapted to recognize the differential pressure p_{d}.

The method comprises the steps of
measuring the differential pressure p_{d} by means of the safety unit, and
starting to run a safety measure if the differential pressure p_{d} is below a predefined pressure value, in particular if p_{d}≤500 Pa, very particular if p_{d}≤50 Pa.

In a further advantageous embodiment of the method, the safety measure is:
a shutdown of the robot (1000), in particular if p_{d}≤ 50 p_{d}, or
a return of the robot (1000) to the safety zone, in particular if p_{d}≤500 Pa, or
a return of the robot (1000) to the docking station, wherein in particular, at the docking station, the robot might refill the cavity manually or automatically or controlled by remote control with an inert gas from a cartridge to restore the overpressure in the cavity, or
filling the cavity with an inert gas, in particular nitrogen, from a cartridge that is comprised in the robot to restore the gas pressure, if p_{d}≤500 Pa.

In a further advantageous embodiment of the invention, the method comprises additionally the step of measuring the differential pressure p_{d} in an interval of at least once per second.

A fifth aspect refers to the use of the legged robot for performing tasks in an explosive environment.

Other advantageous embodiments are listed in the dependent claims as well as in the description below.

### BRIEF DESCRIPTION OF THE DRAWINGS

The invention will be better understood and objects other than those set forth above will become apparent from the following detailed description thereof. Such description makes reference to the annexed drawings, wherein:

FIG. 1 discloses a schematic of a legged robot according to an embodiment of the invention;

FIG. 2 discloses a further embodiment of the legged robot according to an embodiment of the invention;

FIG. 3 discloses an actuator according to an embodiment of the invention;

FIG. 4 discloses a cross section of an actuator according to an embodiment of the invention;

FIG. 5 discloses a cable gland according to an embodiment of the invention; and

FIG. 6 discloses an embodiment of a legged robot comprising an actuator that is connected to the robot torso by means of a cable and a cable gland.

### MODES FOR CARRYING OUT THE INVENTION

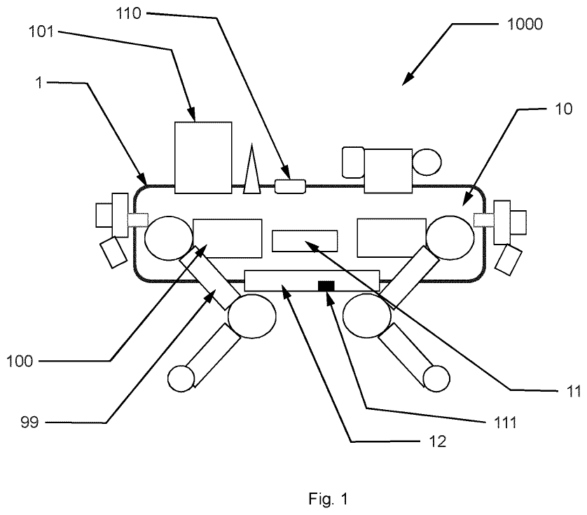

FIG. 1 discloses a legged robot 1000 comprising a torso 1 with a cavity 10. The cavity 10 encloses at least one robot component 11. In addition, the legged robot 1000 comprises at least one leg 99 with at least one actuator 100. The actuator 100 comprises an explosion proof housing. The explosion proof housing comprises at least one flame proof gap 105.

Advantageously, as shown in FIG. 1, the at least one actuator 100 is arranged directly adjacent to the robot torso 1.

An absolute pressure p_{c} within the cavity 10 is higher than an ambient pressure pₐ. Therefore, there is an overpressure in the cavity 10.

In a further advantageous embodiment of the invention, a differential pressure p_{d} measured between the absolute cavity pressure p_{c} and the ambient pressure pₐ outside the robot torso is p_{d}=p_{c}−pₐ is p_{d}≥500 Pa.

Advantageously, the legged robot 1000 comprises a pressure sensor unit 111 to measure the differential pressure p_{d}.

In a further advantageous embodiment of the legged robot 1000, it comprises a DC fan 110, wherein the DC fan 110 is adapted to be explosion proof, in particular, wherein a housing of the DC fan 110 comprises at least one flame proof gap 105. The exemplary flame proof gap 105 is visible in FIG. 4.

In a further advantageous embodiment of the legged robot 1000, at least one robot component 11 is a LiDAR 101, a sensor element 111, an electronic component, a battery 12 and/or a camera. Various such elements are shown in FIG. 1.

All the robot components 11 are in fluid connection with the cavity 10 and therefore are in an environment with the same overpressure as the cavity 10 is, since the cavity 10 is sealed towards the outer environment. Some of the components 11 might be fully enclosed by the cavity 10, some other components 11 might be partially enclosed by the cavity 10, but are sealed towards the outer environment.

In a further advantageous embodiment of the legged robot 1000, the robot 1000 comprises a safety unit to recognize the differential pressure p_{d}. Wherein in an intended use of the legged robot 1000, the safety unit is adapted to monitor the differential pressure p_{d} and to start running a safety measure if the differential pressure p_{d} is below a predefined value, in particular if p_{d}≤500 Pa, very particular if p_{d}≤50 Pa.

Advantageously, the safety measure is:
a shutdown of the robot 1000, in particular if p_{d}≤50 Pa,
a return of the robot 1000 to the safety zone, in particular if p_{d}≤500 Pa, or
a return of the robot 1000 to the docking station, or
automatically or manually refilling the cavity 10 with gas from a gas cartridge to a predefined overpressure that is comprised within the robot 1000 if p_{d}≤500 Pa. In particular, the cartridge is a nitrogen cartridge.

Therefore, a method to provide a flame proof legged robot 10000 would comprise the steps of measuring the differential pressure pₐ by means of the safety unit, and starting to run a safety measure if the differential pressure pₐ is below a predefined pressure value, in particular if p_{d}≤500 Pa, very particular if p_{d}≤50 Pa.

In particular, such a legged robot 1000 is used for performing tasks in an explosive environment.

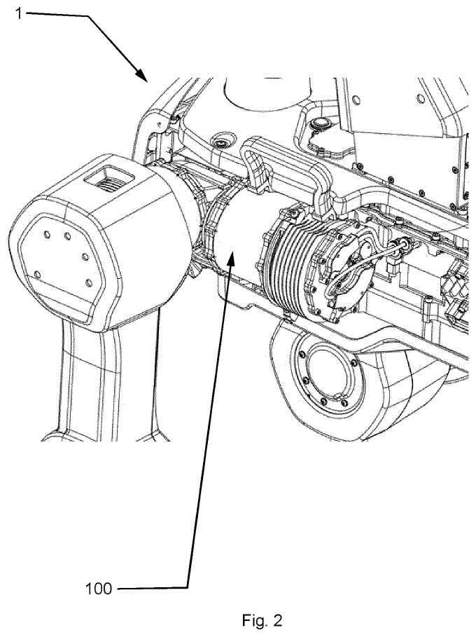

FIG. 2 shows a further embodiment of a legged robot 1000 from the outside. Therefore the torso 1 is visible from the outside and the adjacently arranged actuator 100.

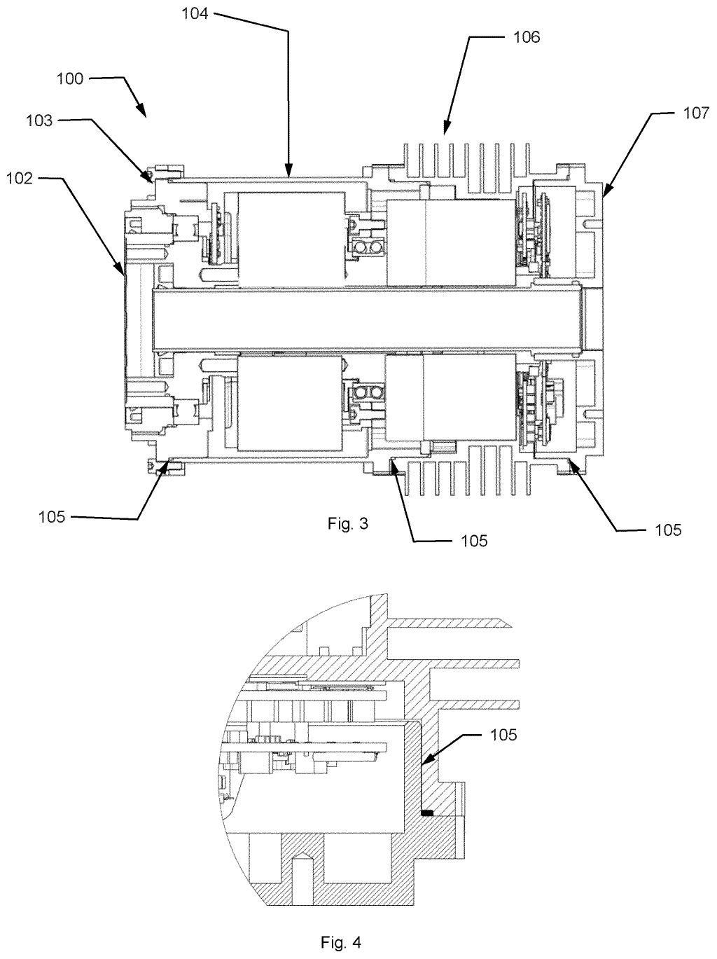

FIG. 3 shows a cross section of an embodiment of the actuator 100 of the embodiment of the legged robot 1000 as shown in FIG. 2. The explosion proof housing of the actuator 100 comprises flame gaps 105.

In an advantageous embodiment as shown in FIG. 3, the actuator 100 comprises within the explosion proof housing the following sections arranged along a longitudinal axis:
a dynamic joint with a moving shaft 102 as the moving section and a output flange 103 as the static section,
a gear housing 104
a stator housing 106, and
a back cap 107.

Between each section is at least one flame proof gap 105 arranged.

FIG. 4 discloses a section of the actuator 100 of the embodiment as shown in FIG. 3. In particular visible in FIG. 4 is a flame gap 105 of the housing of the dynamic joint 100 (a flame gap 105 is the black line marked with arrow 105).

Advantageously, the flame gaps have a minimum of 6 mm in length and less than 0.2 mm in width.

FIG. 5 shows a cross section of an advantageous embodiment of the cable gland 2. The cable gland 2 comprises a separator 20 with at least one cable inlet 22 and at least one cable outlet 21.

The cable inlet 22 is adapted to receive at least one cable connection 200 that is adapted to connect an electrical component of the actuator 100 of the robot 1000.

The cable outlet 21 is adapted to exit the cable connection 200 that is adapted to connect to one or more electrical components and/or a battery 12 within the cavity 10.

The separator 20 is adapted to receive a bare section 201 of the cable connection 200. The bare section 201 refers to a section of the cable connection 200 along which the cable connection 200 has no cable jacket.

In a further advantageous embodiment of the cable gland 2, the bare section 201 is soldered with a conducting material, in particular a metal, to prevent gas accumulation between the individual wires of the bare section 201. The separator plenum between the inlet 22 and outlet 21 opening is then completely potted with glue in order to close the cavity gas tight.

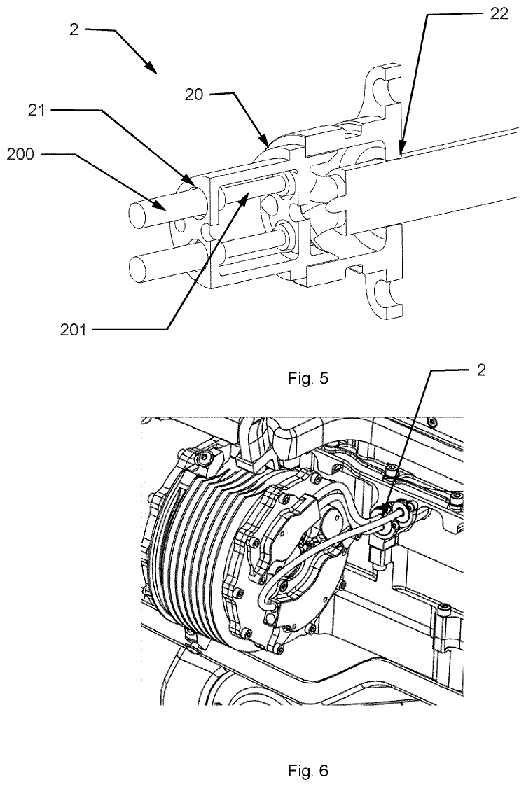

FIG. 6 shows an embodiment of a legged robot 1000 of FIG. 2 comprising a torso 1 and an actuator 100, wherein at least one cable connection 200 is adapted to connect an electrical component of the actuator 100 of the robot 1000 to one or more electrical components and/or a battery 12 within the cavity 10.

The cable connection 200 from the actuator of the dynamic joint enters the torso 1 respectively the cavity 10 at the cable gland 2 through the cable inlet 22 and exits the cable gland 2 through the cable outlet 21.

In particular it is visible in FIG. 6 how the cable connection 200 leaves the actuator 100, where the inner cable might be exposed to ambient conditions. The cable enters the torso 1 by means of the cable gland 2, where the separator 20 prevents the gas from the environment to enter the cavity 10 of the torso 1.

### Reference Table

1 Torso
10 Cavity
11 At least one robot component
12 Battery
100 Actuator
101 LIDAR system
102 Dynamic joint: output shaft
103 Dynamic joint: output flange
104 Gear housing with gear box
105 Flame proof gaps
106 Stator housing
107 Back cap
110 DC fan
111 Pressure sensor unit or pressure sensor
1000 Legged robot
2 Cable gland
20 Separator
200 Cable connection
201 Bare section of the cable connection
21 Cable outlet
22 Cable inlet
99 At least one leg

1. A legged robot, in particular a quadruped robot, comprising:
a torso comprising a cavity defining the inner space within the robot torso and enclosing at least one robot component,
at least one leg with at least one actuator comprising an explosion proof housing, and
a gas tight cable gland to electrically connect a wire from the actuator to one or more of the robot components in the cavity,
wherein an absolute pressure p_{c} within the cavity is higher than an ambient pressure pₐ, and
wherein the explosion proof housing of the actuator comprises at least one flame proof gap.

2. The legged robot according to claim 1, wherein the actuator comprises a dynamic joint with a moving section and a static section, with the at least one flame proof gap arranged at the interface of the moving section and the static section.

3. The legged robot according to claim 2, wherein the actuator comprises within the explosion proof housing the following sections arranged along a longitudinal axis:
the dynamic joint with a moving shaft as the moving section and an output flange as the static section,
a gear housing,
a stator housing, and
a back cap,
wherein between each section there is arranged at least one flame proof gap.

4. The legged robot according to claim 1, wherein the actuator is directly adjacent to the outside of the torso.

5. The legged robot according to claim 1 wherein a differential pressure p_{d}=p_{c}−pₐ is p_{d}≥500 Pa, in particular, wherein the robot comprises a differential pressure sensor unit to measure the differential pressure pd.

6. The legged robot according to claim 1, comprising a DC fan, wherein the DC fan is adapted to be explosion proof, in particular, wherein a housing of the DC fan comprises at least one flame gap.

7. The legged robot according to claim 1, wherein the at least one robot component is a LIDAR, a sensor element, an electronic component, a battery, and/or a camera.

8. (canceled)

9. The legged robot according to claim 2, comprising the cable gland to connect a wire from the actuator or the dynamic joint or any of the other sections of the actuator to a robot component within the cavity, comprising
a separator with at least one cable inlet and at least one cable outlet, and
at least one cable connection adapted to connect an electrical component of the actuator of the robot to one or more electrical components and/or a battery within the torso,
wherein the cable connection enters the cable gland through the cable inlet and exits the cable gland through the cable outlet, and
wherein a bare section of the cable connection arranged within the separator,
wherein the bare section is soldered up, and
wherein the separator is filled with an insulating material.

10. The legged robot according to claim 1, wherein at least one electrical component of the at least one actuator is electrically connected to one or more electrical components and/or a battery of the torso, in particular by means of a wire that passes the cable gland.

11. The legged robot according to claim 1, comprising a safety unit to recognize the differential pressure p_{d},
wherein in an intended use of the legged robot, the safety unit is adapted to monitor the differential pressure p_{d} and to start running a safety measure if the differential pressure p_{d} is below a predefined pressure value, in particular if p_{d}≤500 Pa, very particular if p_{d}≤50 Pa.

12. The legged robot [(1000)] according to claim 10, wherein the safety measure is:
a shutdown of the robot, in particular if p_{d}≤50 Pa,
a return of the robot to a safety zone, in particular if p_{d}≤500 Pa, or
a return of the robot to a docking station.

13. The legged robot according to claim 1, comprising a gas cartridge adapted to control the cavity pressure p_{c}, in particular adapted to fill the cavity with gas from the cartridge if the differential pressure is p_{d}≤500 Pa.

14. A cable gland for a legged robot according to claim 1, comprising a separator with at least one cable inlet and at least one cable outlet.
wherein the cable inlet is adapted to receive at least one cable connection that is adapted to connect an electrical component of an actuator of a leg of the robot
wherein the cable outlet is adapted to exit the cable connection that is adapted to connect to one or more electrical components and/or a battery within a cavity of a torso, and
wherein the separator is adapted to receive a bare section of the cable connection.

15. The cable gland according to claim 13, comprising
the separator, and
the at least one cable connection adapted to connect the electrical component of the actuator of the leg of the robot to one or more electrical components and/or a battery within the cavity of the torso, wherein the cable connection enters the cable gland through the cable inlet and exits the cable gland through the cable outlet, and
wherein a bare section of the cable connection is soldered up and wherein the separator is filled with an insulating material.

16. An actuator for a robot according to claim 1.

17. A method to provide an explosion proof legged robot, wherein the legged robot comprises:
the torso, and
the at least one leg with at least one actuator with an explosion proof housing, wherein the explosion proof housing of the actuator has at least one flame proof gap,
a pressure sensor unit adapted to measure a differential pressure p_{d} between a cavity pressure p_{c} and an ambient pressure pₐ, wherein p_{c}>pₐ,
a safety unit adapted to recognize the differential pressure pₐ, the method comprises the steps of:
measuring the differential pressure p_{d} by means of the safety unit, and
starting to run a safety measure if the differential pressure p_{d} is below a predefined pressure value, in particular if p_{d}≤500 Pa, in particular if p_{d}≤50 Pa.

18. The method according to claim 17, wherein the safety measure is:
a shutdown of the robot, in particular if p_{d}≤50 Pa, or
a return of the robot to a safety zone, in particular if p_{d}≤500 Pa, or a return of the robot to a docking station, or
filling the cavity with gas from a cartridge that is comprised in the robot to restore the gas pressure, if p_{d}≤500 Pa.

19. Use of a legged robot according to claim 1 for performing tasks in an explosive environment.
